(19) United States
(12) Patent Application Publication
(10) Pub. No.: US 2026/0220063 A1
(43) Pub. Date: Jul. 30, 2026

(54) METHODS TO ENSURE THE SECURITY OF SERVER PARTITIONING

(71) Applicant: Intel Corporation, Santa Clara, CA (US)

(72) Inventors: Eric J. DEHAEMER, Shrewsbury, MA (US); Simin XIONG, Hillsboro, OR (US); Mahesh S. NATU, Folsom, CA (US); Gurjeet SINGH, Folsom, CA (US)

(21) Appl. No.: 19/630,219

(22) Filed: Mar. 26, 2026

(51) Int. Cl. G06F 13/40

(52) U.S. Cl. CPC G06F 13/4068

(57) ABSTRACT

Methods and apparatus to ensure the security of server partitioning. The method is performed on a multi-socket platform including first and second sockets interconnected by a socket-to-socket interconnect, the multi-socket platform being capable of being configured in a first partition mode with a single partition using both the first and second sockets and a second partition mode under which the first and second sockets are partitioned as respective first and second partitions. Following the platform being operated in the single partition mode, the first socket is rebooted to be operated as local socket in a separate partition under the second partition mode and under which communication over the socket-to-socket interconnect is disabled without using any communication between the first and second sockets. Softstrap and hardware strap partition mode configuration schemes are provided to implement the method on various multi-socket platform architectures.

### BACKGROUND INFORMATION

Cloud-based computing has become ubiquitous in recent years. Cloud Service Providers (CSPs) such as Amazon (Amazon Web Services), Microsoft (Azure), and Google (Google Cloud) enable users called “tenants” to lease physical infrastructure and/or virtual resources hosted by underlying physical infrastructure. The physical infrastructure generally will include compute, memory, and storage resources, which may be deployed via unified devices, such as servers, or under “disaggregated” architectures under which compute, memory, and storage resources are grouped in separate apparatus.

Server platforms may include single-socket platforms or multi-socket platforms. Under this terminology, a “socket” corresponds to a Central Processing Unit (CPU) or processor System on a Chip (SoC) that includes a CPU. The CPUs include multiple processor cores and are sometimes referred to as multi-core processors. A two-socket platform may be deployed as two single-socket platforms operating in separate partitions, or a two-socket platform operating under a single partition. Under the two single-socket platform configuration, it is possible for the CSP to lease one single-socket platform to a first tenant, while leasing the second single-socket platform to a second tenant.

Under a two-socket platform, the sockets are interconnected via a high-speed socket-to-socket interconnect. When operated in a single partition, the interfaces at each end of the socket-to-socket interconnect exchange electrics parameters and security information and perform link training. When switching from two sockets (or multi-socket) one partitions to single-socket two partitions (or multi-partition) systems, there are potential security risks to let the different partitions, which are leased by different tenants, to exchange information.

### BRIEF DESCRIPTION OF THE DRAWINGS

The foregoing aspects and many of the attendant advantages of this disclosure will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating components for implementing a softstrap scheme, according to one embodiment;

FIG. 2 is a high-level flow diagram illustrating operations performed for a softstrap partition mode scheme, according to one embodiment;

FIG. 2a shows a variant of the flow diagram of FIG. 2a where the UXI link and interface is replaced with a UPI link, according to one embodiment;

FIG. 3 is a diagram illustrating components for implementing in a hardware strap partition mode solution, according to one embodiment according to one embodiment;

FIG. 4 is a high-level flow diagram illustrating operations performed for a hardware (HW) strap partition mode scheme, according to one embodiment;

FIG. 4a shows a variant of the flow diagram of FIG. 2a where the UXI link and interface is replaced with a UPI link, according to one embodiment;

FIG. 5 is a schematic diagram illustrating a two-socket platform with a PCH and configured to implement a softstrap mode partition scheme, according to one embodiment;

FIG. 5a is schematic diagram illustrating a two-socket platform with a PCH and configured to implement a HW strap mode partition scheme, according to one embodiment

FIG. 6 is a schematic diagram illustrating a two-socket platform configured to implement a softstrap mode partition scheme, according to one embodiment;

FIG. 6a is schematic diagram illustrating a two-socket platform configured to implement a HW strap mode partition scheme, according to one embodiment

FIG. 7 is a diagram of a platform architecture configured to implement the softstrap mode partition scheme, according to one embodiment;

FIG. 7a is a diagram of a platform architecture configured to implement the HW strap mode partition scheme, according to one embodiment; and

FIG. 8 is a schematic diagram illustrating further details of an integrated boot support block, according to one embodiment.

### DETAILED DESCRIPTION

Embodiments of methods and apparatus to ensure the security of server partitioning are described herein. In the following description, numerous specific details are set forth to provide a thorough understanding of embodiments disclosed herein. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

As used herein, the term “socket” refers to a Central Processing Unit (CPU) or System on a Chip (SoC) processor. This “socket” terminology comes from historical platform implementations under which a CPU or SoC chip or package was/is installed in some type of socket that was/is coupled to a motherboard, main system board, etc. Non-limiting examples of sockets include Land Grid Arrays (LGAs), Pin Grid Arrays (PGAs) and Ball Grid Arrays (BGAs). Some of the drawing figures herein will show components labeled as sockets, while other drawing figures will be labeled CPU or SoC. As will be recognized by those skilled in the art, a CPU or SoC will be installed in a respective socket.

As used herein, the term “partition” and “partitioning is associated with hardware partitioning as opposed to partitioning implemented using software (aka logical or virtual partitioning). For example, under a two-socket platform that is partitioned into two separate partitions, each partition includes its own separate set of hardware resources, including compute, memory, and I/O resources and where hardware resources are not shared between the two partitions. For a multi-socket platform with more than two sockets, the resources for each partition are separate and not shared. For example, a four-socket platform may be configured in any of a single partition, two partitions, three partitions, and four partitions.

In accordance with a first solution, a softstrap is configured by a local trusted baseboard management controller (BMC) using an authenticated and authorized accessible-only region of an integrated firmware image (IFWI) when the partition mode is changed. In one embodiment, the power unit (P-unit) can read the softstrap information from the locally accessible-only IFWI to disable the socket-to-socket link (e.g., Ultra Path Interconnect (UPI) or Ultra eXtensible Interconnect (UXI) link) before bringing up the socket-to-socket link. Accordingly, when the multi-socket platform is switched from a single partition configuration to multiple single socket partitions, the data path between the sockets can be isolated to ensure security or a local socket.

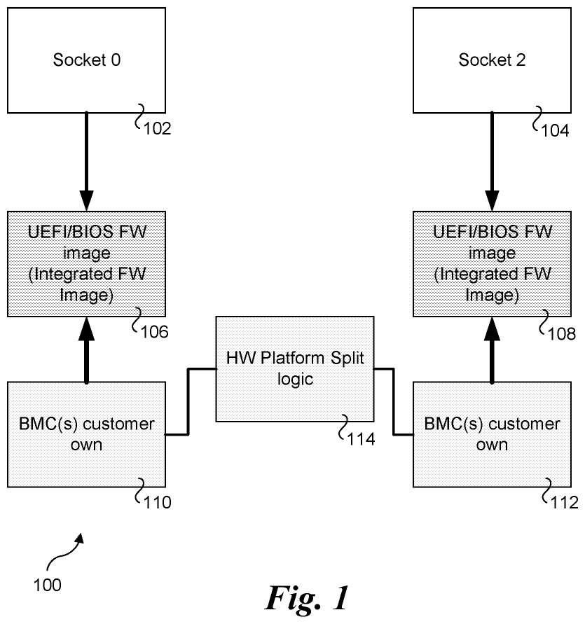

Diagram 100 in FIG. 1 shows the components for implementing the softstrap scheme, according to one embodiment. The components include sockets 102 and 104 (respectively labeled sockets 0 and 1), UEFI/BIOS (Universal Extensible Firmware Interface/Basic Input Output System) firmware images 106 and 108, BMC modules 110 and 112, and hardware (HW) platform split logic 114. HW Platform split logic 114 decides whether the server/platform will be used as one multi-socket partition or multiple one socket partitions.

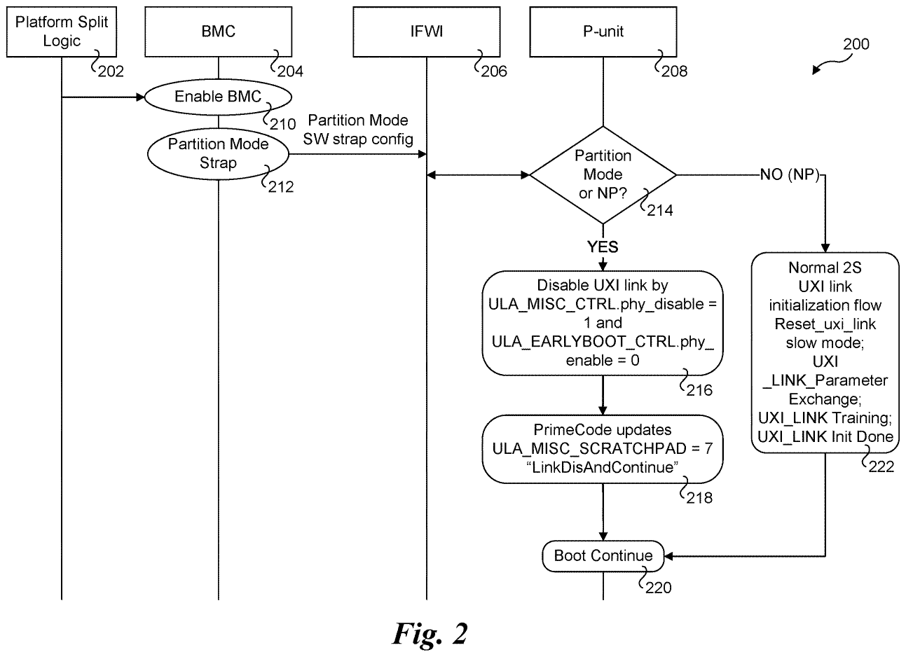

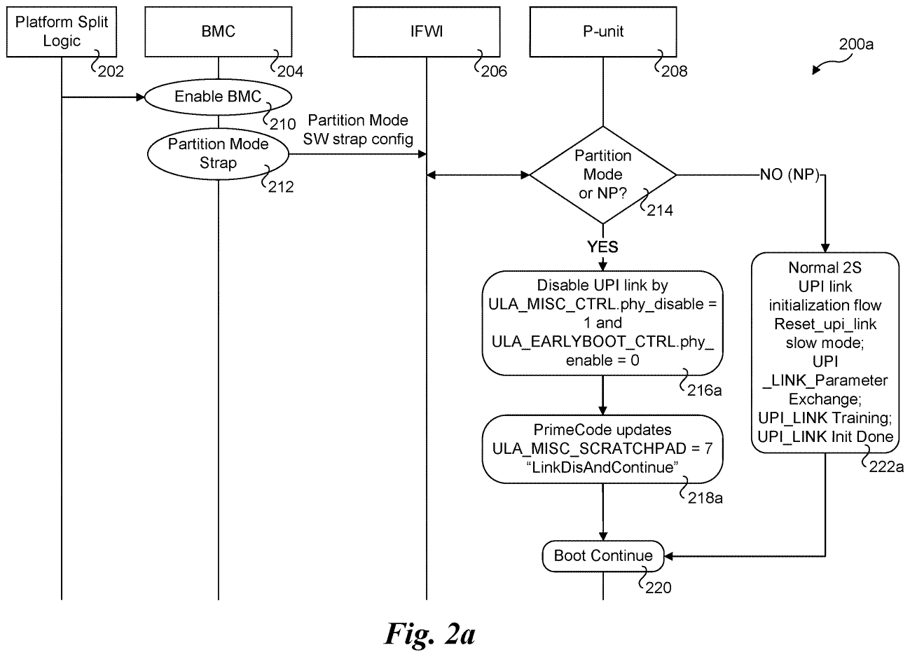

When the platform is configured as one multi-socket partition, the UXI link between the sockets is configured and trained in the conventional manner. When the platform is configured as multiple one socket partitions, a dedicated BMC module is enabled for each one socket partition. Each dedicated BMC module will access its local IFWI flash and configure the softstrap to tell the P-unit that current usage is a single socket configuration for the local socket. The P-unit will read the softstrap at an earlier boot stage and disable the UXI port or link before it is initialized (trained), as shown in the high-level boot flow diagram 200 in FIG. 2.

As shown in flow diagram 200, the components that perform the boot flow include platform split logic 202, a BMC 204, local IFWI 206, and P-unit 208. In one embodiment P-unit 208 is a microcontroller responsible for power and performance features like C-states, P-states, etc., in addition to the operations shown in the diagrams herein.

The boot flow begins with platform split logic 202 sending a message 210 to BMC 204 to enable the BMC. Message 210 will also include information identifying the partition mode. BMC 204 will then use the partition mode strap 212 to configure the partition mode software strap configuration in its local IFWI 206. As part of the boot flow, P-unit 208 will read IFWI 206 to determine the partition mode. As shown in a decision block 214, when the partition mode configuration is set to multiple single-socket partitions, the answer to decision block 214 is YES and the logic proceeds to a block 216 in which the UXI link is disabled. In the illustrated embodiment this is accomplished by setting,
ULA_MISC_CTRL.phy_disable=1; and
ULA_EARLYBOOT_CTRL.phy_enable=0

Next, in a block 218 the PrimeCode updates ULA_MISC_SCRATCHPAD=7, which corresponds to a setting of “LinkDisAndContinue” (Link disconnect and continue). As shown in a block 220 the boot flow then continues.

Returning to decision block 214, if the IFWI partition mode setting identifies no partition (i.e., the platform is configured as a single partition), the answer to decision block 214 is NO and the logic proceeds to a block 222 to perform a normal two-socket UXI link initialization flow. This initialization flow includes,
1. Reset_uxi_link slow mode;
2. UXI_LINK_Parameter Exchange;
3. UXI_LINK Training; and
4. UXI_LINK Init Done

First, the UXI link is reset to slow mode. Second, the respective interfaces on the two ends of the UXI link exchange link parameters. This is followed by UXI link training. Upon completion of UXI link training a notification is provided by the interfaces indicating the UXI link initialization has been completed. Following completion of the UXI link initialization flow operations the logic proceeds to block 220 to continue the boot flow.

FIG. 2a shows a flow diagram 200a that is a variant of flow diagram 200 where the UXI link is replaced with a UPI link. The changes are in shows in blocks 216a, 218a, and 222a. As with block 222 in flow diagram 200, the operation in block 222a performs a normal two-socket UPI link initialization flow. This initialization flow includes,
1. Reset_upi_link slow mode;
2. UPI_LINK_Parameter Exchange;
3. UPI_LINK Training; and
4. UPI_LINK Init Done

First, the UPI link is reset to slow mode. Second, the respective interfaces on the two ends of the UPI link exchange link parameters. This is followed by UPI link training. Upon completion of UPI link training a notification is provided by the interfaces indicating the UPI link initialization has been completed. Following completion of the UPI link initialization flow operations the logic proceeds to block 220 to continue the boot flow.

In accordance with a second embodiment, a hardware strap in the local socket only is used to determine if the platform works in the two single-socket partitioned mode or the two socket single partition mode. When the platform is configured to operate in the two single-socket partitioned mode, the UXI port will be disabled and the LEP process will not initiate, such that no information exchange will happened between the two sockets.

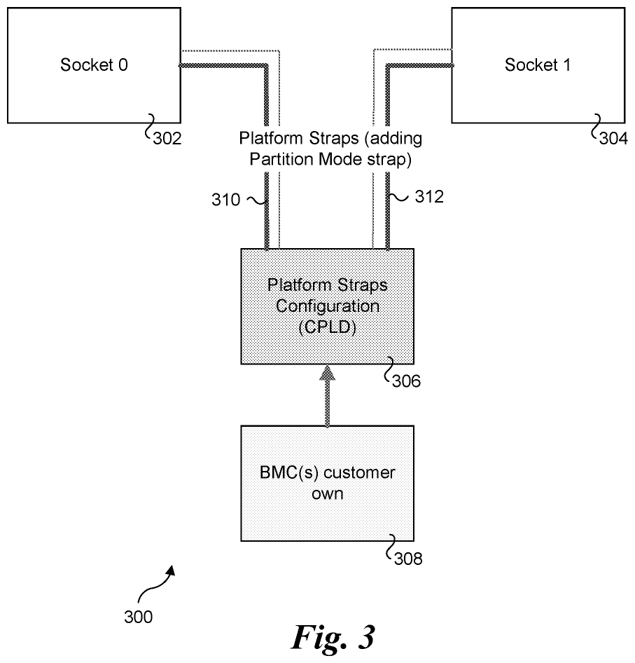

FIG. 3 shows a diagram 300 illustrating the components implemented in the hardware strap solution, according to one embodiment. The components include sockets 302 and 304 (respectively labeled Socket 0 and Socket 1), a platform straps configuration block 306 implemented as a complex programmable logic device (CPLD), and a BMC(s) module 308 owned by a customer (e.g., a CSP tenant). platform straps configuration block 306 is coupled in communication with each of socket 302 and 304, as shown by respective communication paths 310 and 312.

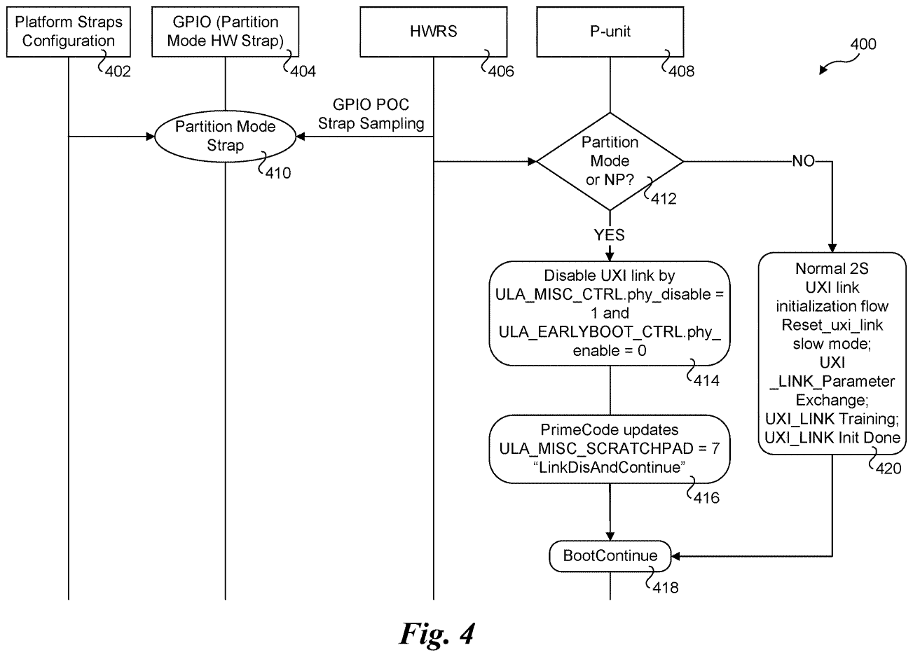

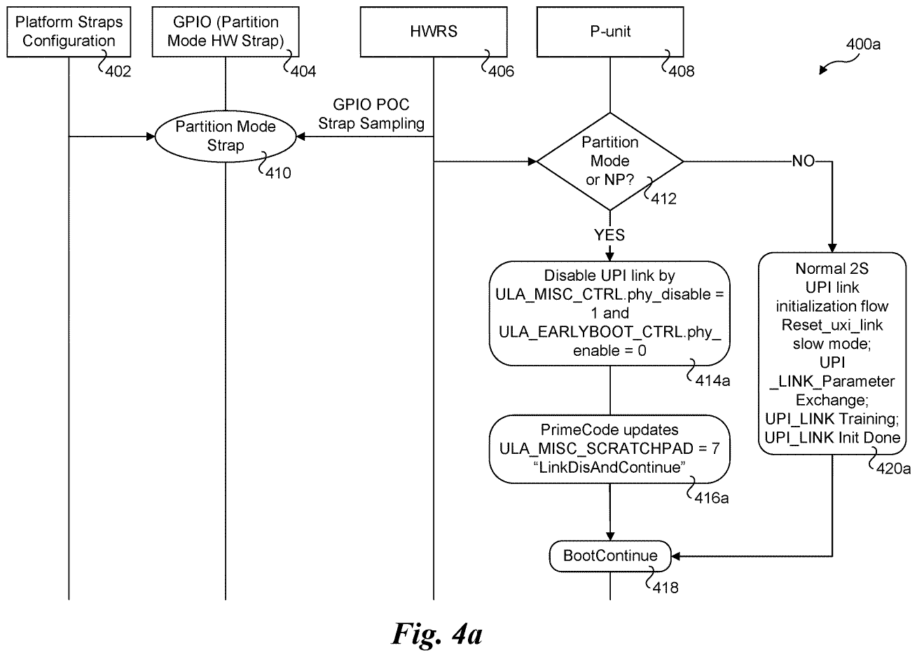

As shown in a high-level boot flow diagram 400 of FIG. 4, the components that perform the boot flow include platform straps configuration block 402, a general purpose input-output (GPIO) power on configuration (POC) strap 404 used for the partition mode hardware strap, a hardware reset sequencer (HWRS) block 406, and a P-unit 408.

The flow begins with platform straps configuration block 402 sending a signal to set a partition mode strap 410 to GPIO POC strap 404. The signal will either be a logic ‘1’ or logic ‘0’ signal and will set the partition mode accordingly. HWRS 406 will sample the GPIO POC strap and expose the partition strap mode setting to P-unit 408. As shown in a decision block 412, when the partition mode configuration is set to multiple single-socket partitions (partition mode is ‘1’), the answer to decision block 412 is YES and the logic proceeds to a block 414 in which the UXI link is disabled. In the illustrated embodiment this is accomplished by setting,
ULA_MISC_CTRL.phy_disable=1; and
ULA_EARLYBOOT_CTRL.phy_enable=0

Next, in a block 416 the PrimeCode updates ULA_MISC_SCRATCHPAD=7, which corresponds to a setting of “LinkDisAndContinue” (Link disconnect and continue). As shown in a block 418 the boot flow then continues.

Returning to decision block 412, if the GPIO POC strap sampling identifies no partition (i.e., the platform is configured as a single partition, partition mode=‘0’), the answer to decision block 412 is NO and the logic proceeds to a block 420 to perform a normal two-socket UXI link initialization flow. This initialization flow includes,
1. Reset_uxi_link slow mode;
2. UXI_LINK_Parameter Exchange;
3. UXI_LINK Training; and
4. UXI_LINK Init Done

This is the same as what is performed in block 222 above. First, the UXI link is reset to slow mode. Second, the respective interfaces on the two ends of the UXI link exchange link parameters. This is followed by UXI link training. Upon completion of UXI link training a notification is provided by the interfaces indicating the UXI link initialization has been completed. Following completion of the UXI link initialization flow operations the logic proceeds to block 418 to continue the boot flow.

FIG. 4a shows a flow diagram 400a that is a variant of flow diagram 400 where the UXI link is replaced with a UPI link. The changes are in shows in blocks 414a, 416a, and 420a. As with block 420 in flow diagram 400, the operation in block 222a performs a normal two-socket UPI link initialization flow. This initialization flow is the same as in block 222a in FIG. 2a discussed above.

### Example Platforms

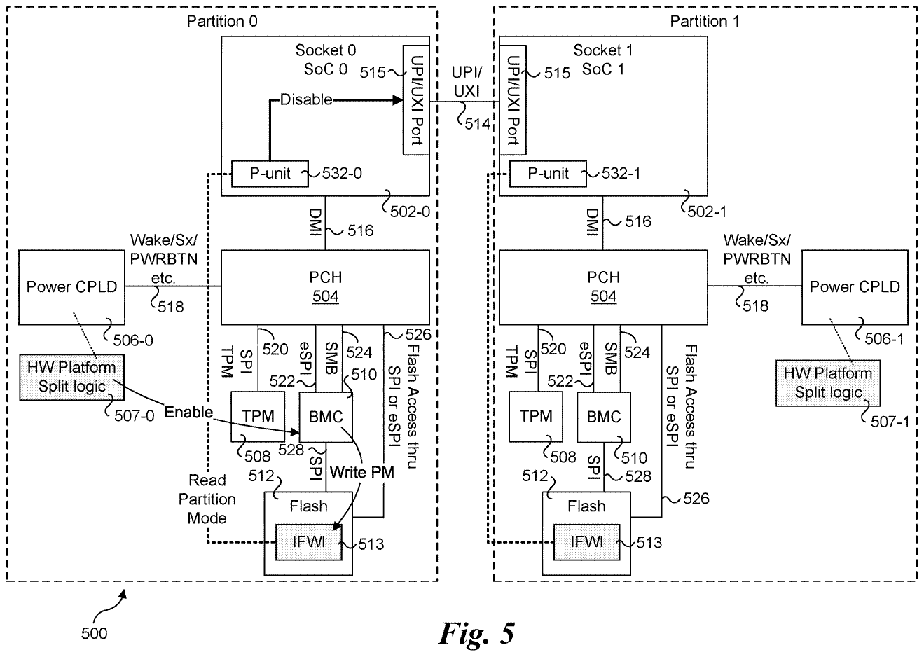

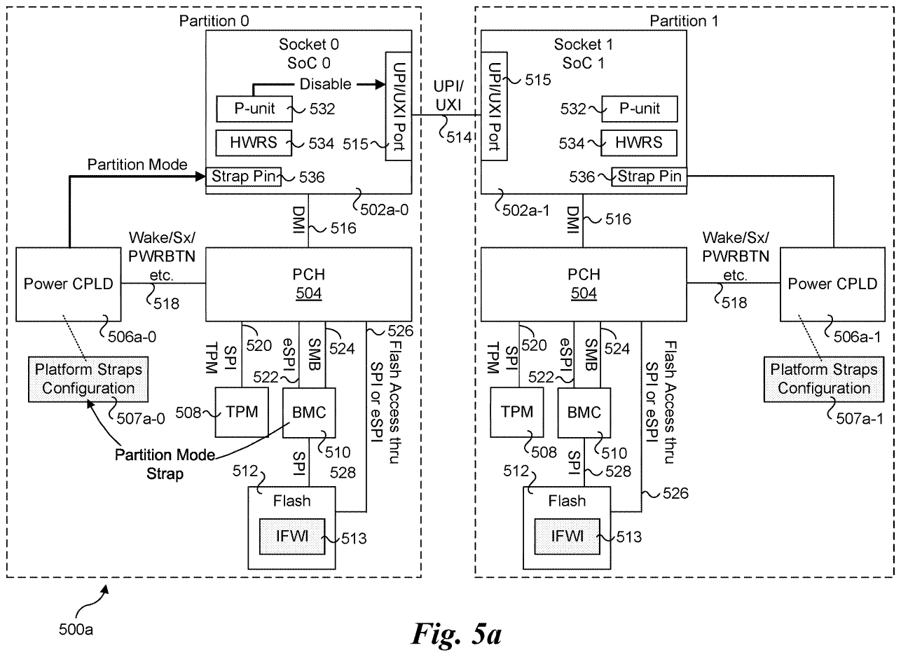

Example configurations for two-socket platforms are shown in FIGS. 5, 5a, 6, 6a, 7, and 7a. In addition to the platform configurations illustrated in these figures, embodiments of the solutions described and illustrated herein may be used for other platform configurations.

FIG. 5 shows a two-socket platform 500 including SoCs 502-0 and 502-1. Each SoC is coupled to its own set of hardware resources including a platform controller hub (PCH) 504, a respective power CPLD (complex programmable logic device) 506-0 or 506-1, a trusted platform module (TPM) 508, a baseboard management controller (BMC) 510, and a flash storage device 512 in which IFWI 513 is stored. SoCs 502-0 and 502-1 are interconnected via a socket-to-socket interconnect 514, which in the illustrated example is an UPI or a UXI link. SoCs 502-0 and 502-1 include respective UPI or UXI ports 515 at opposing ends of socket-to-socket interconnect 514. Each of SoCs 502-0 and 502-1 is connected to its respective PCH 504 via a Direct Media Interface (DMI) 516.

Power CPLD 506-0 and 506-1 provides various inputs to a respective PCH 504, such as wake signals, power state control (Sx) signals, power button signals, etc. 518. In the illustrated embodiment, CPLD 506-0 and 506-1 are further configured to implement HW platform split logic 507-0 and 507-1. Under alternative configurations, HW platform split logic 507-0 and 507-1 may be implemented in their own CPLDs or other programmable logic such as FPGA (Field Programmable Gate Arrays).

TPM 508 is connected to PCH 504 via a serial peripheral interface (SPI) TMP link 520. BMC 510 is connected to PCH 504 via an enhanced serial peripheral interface (eSPI) link 522 and via a serial management bus (SMB) 524. In addition to the links shown, other types of low pin count (LPC) buses may be used.

Platform firmware comprising IFWI 513 is stored in flash storage device 512, which is coupled to PCH 504 via an SPI or eSPI link 526 and coupled to BMC 510 via an SPI link 528. In the illustrated example, each of SoC 502-0 and 502-1 is associated with a respective partition (0 and 1). When operated in the two-partition mode, the circuitry in each partition operates independent from the circuitry in the other partition. In the illustrated example, each partition has its own firmware storage device (Flash storage device 512). In some embodiments, the platform firm comprises Unified Extensible Firmware Interface (UEFI) firmware.

Each of SoCs 502-0 and 502-1 includes a respective P-unit 532 (532 -0 and 532-1) in addition to components that are not illustrated, such as processor cores, caches, and various intellectual property (IP) blocks. Under a platform that includes a PCH, the PCH facilitates communication between components connected to the PCH over the links between the PCH and those components. As will be recognized by those skilled in the art, each link will have a corresponding pair of link interfaces in the components at the opposing ends of the link.

In this example, Socket 0 in partition 0 is the trusted local socket, while Socket 1 in partition 1 is the untrusted remote socket. As illustrated in FIG. 5, P-unit 532-0 reads the partition mode from IFWI 513, as discussed and illustrated above for flow diagram 200. The datapath is via DMI 516, PCH 504, and SPI or eSPI link 526. In this example, the partition mode is the two partition mode and, as a result, P-unit 532-0 will disable the local UPI or UXI port on SoC 502-0.

FIG. 5a shows a two-socket platform 500a comprising another two-socket platform configuration that is similar to two-socket platform 500 wherein like-numbered components have the same configuration in both platforms 500 and 500a. However, rather than configured to implement the operations in flow diagram 200 or flow diagram 200a, two-socket platform 500a is configured to implement the operations in flow diagram 400 or 400a. To facilitate the boot flow, two-socket platform 500a includes platform straps configuration logic 507a-0 and 507a-1, while each of SoCs 502a-0 and 502a-1 include a P-unit 532, an HWRS block 534, and a strap pin 536. As above, platform straps configuration logic 507a-0 and 507a-1 may be implemented in power CPLDs 506a-0 and 506a-1 or may be implemented in their own CLPDs or other programmable logic.

As shown in flow diagram 400 of FIG. 4 and discussed above, platform straps configuration logic is used to set or clear the input (logic ‘1’ or ‘0’) on strap pin 636 to specify the partition mode to be used. In some embodiments, strap pin 636 is a GPIO pin while more generally other types of IO pins on an SoC or CPU may be used as a strap pin. HWRS block 634 samples the logic level on strap pin 636 and provide a signal to P-unit 632 corresponding to the partition mode. In this example, since the partition mode is two partitions, P-unit 632 will disable UPI/UXI port 515 on the local socket (Socket 0).

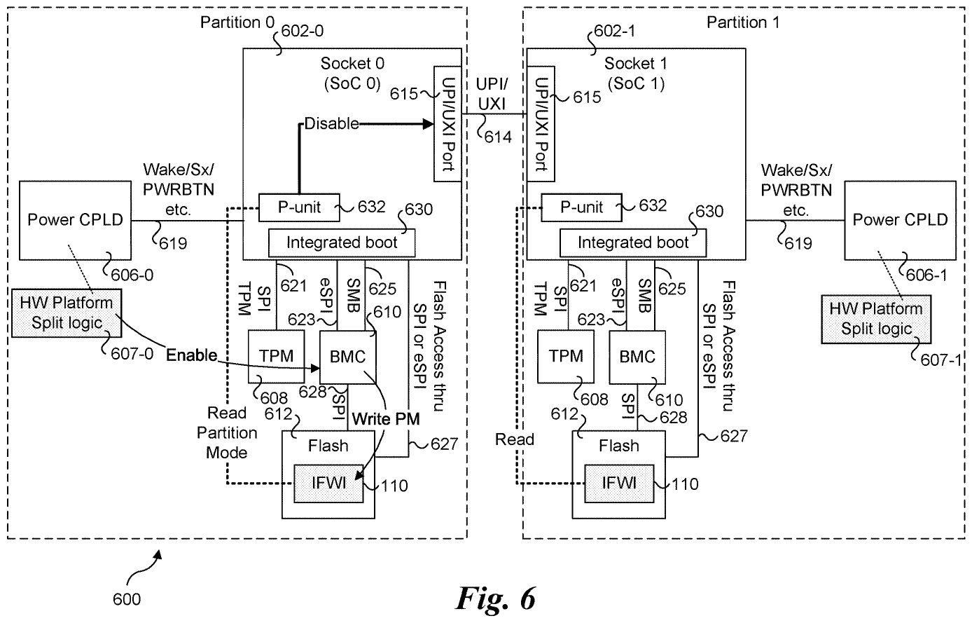

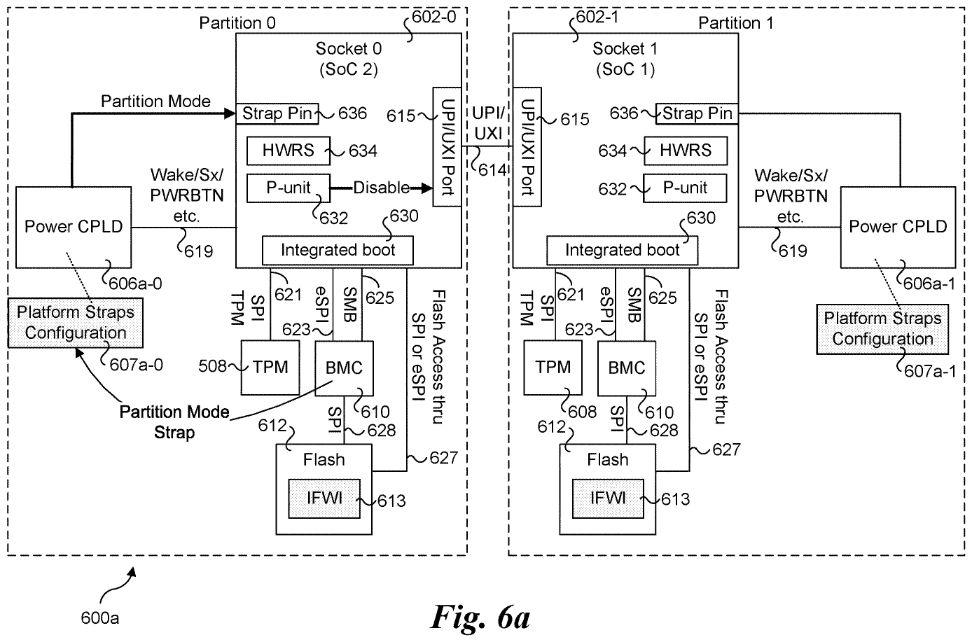

FIG. 6 shows a two-socket platform 600 comprising another two-socket platform configuration employing integrated boot support blocks 630 in each of SoCs 602-0 and 602-1. As further shown, PCHs 504 have been removed, with each of TPM 608, BMC 610, and flash storage device 612 being directly connected to the SoC 602 in its partition. Thus, in partition 0 TPM 608 is connected to SoC 602-0 via an SPI TPM link 621, BMC 610 is connected to SoC 602-0 via an eSPI link 623 and via SMB 625, and flash storage device 612 is connected to SoC 602-0 via an SPI or eSPI link 627 and connected to BMC 610 via an SPI link 628. IFWI 613 is stored in flash storage device 612

SoCs 602-0 and 602-1 are interconnected via a socket-to-socket interconnect 614, which in the illustrated example is a UPI or a UXI link. SoCs 602-0 and 602-1 include respective UPI or UXI ports 615 at opposing ends of socket-to-socket interconnect 614.

Under two-socket platform 600, each of power CPLD 606-0 and 606-1 sends various signals 619 directly to SoC 602-0 and 602-1, respectively. It is noted that the logic in CPLD 606-0 and CPLD 606-1 may differ from CPLD 506-0 and CPLD 506-1 since under platform 500 in FIG. 5 the PCHs provide control signals and other communications with SoCs 502-0 and 502-1, while under platform 600 CPLDs 606-0 and 606-1 are in direct communication with SoCs 502-0 and 502-1. Otherwise, the flow diagram operations used for two-socket platforms 500 and 600 are substantially similar.

FIG. 6a shows a two-socket platform 600a comprising a variant of two-socket platform 600 that is configured to implement a HW strap mode partition scheme. In two-socket platform 600a an ‘a’ has been appended to various component reference numbers in two-socket platform 600, such as SoCs 602a-0 and 602a-1, and CPLDs 606a-0 and 606a-1. two-socket platform 600a further includes platform straps configuration logic 607a-0 and 607a-1, a strap pin 636, and an HWRS block 634. The operations of flow diagram 400 (UXI socket-to-socket link) and flow diagram 400a (UPI). The operations are similar to those shown in two-socket platform 500a with the primary difference being signals and communication are passed directly between various components without using a PCH.

Those skilled in the art will appreciate that selected platform components are illustrated in FIGS. 5, 5a, 6, and 6a, while an actual platform would include additional components including memory controllers and system memory. Rather, the components and links/interfaces shown in FIGS. 5, 5a, 6, and 6a are focused on what are employed for configuring the two-socket platforms into a two single partition mode with respective sockets and with the UPI or UXI ports on the socket-to-socket interconnect disabled or a multi-socket single partition mode where the socket-to-socket interconnect is enabled and trained.

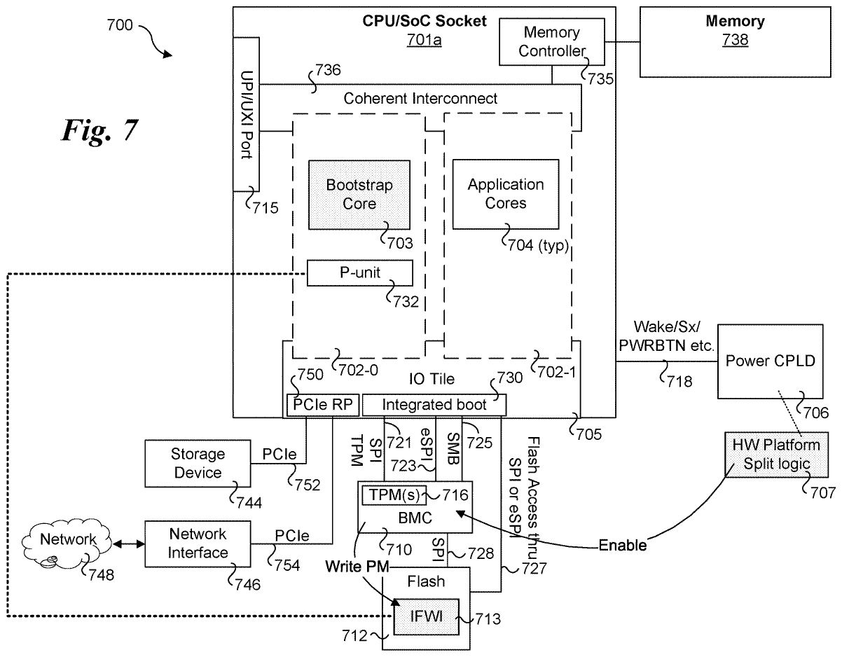

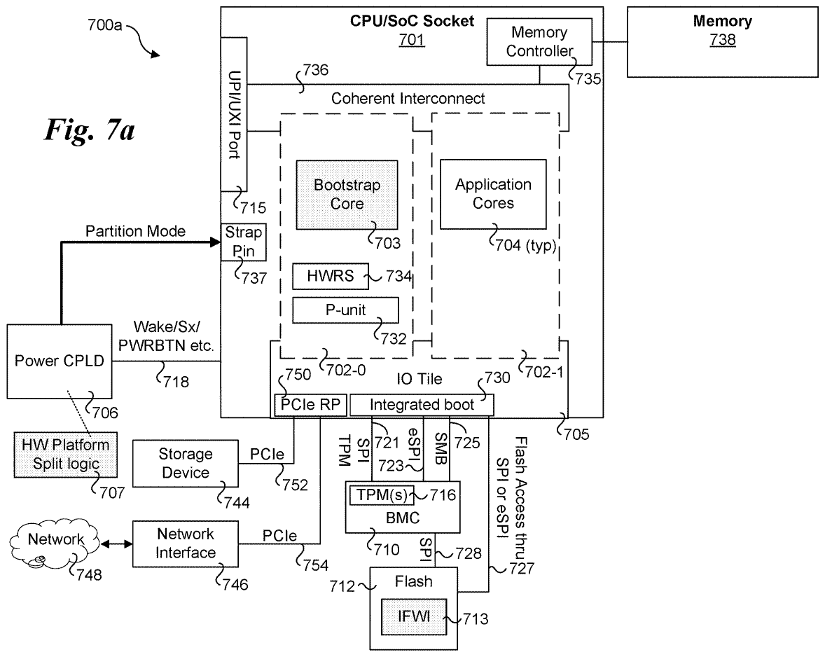

FIG. 7 shows a platform architecture 700 for a single CPU/SoC socket 701 coupled to a set of platform resources. CPU/SoC socket 701 includes core dielets (tiles) 702-0 and 702-1. Each core tile includes multiple cores, including a bootstrap core 703 and application cores 704. CPU/SoC socket 701 also includes an IO tile 705 comprising IO circuitry including an integrated boot support block 730.

The platform resources include boot resources comprising a BMC 710, a flash storage device 712. In the illustrated embodiment, BMC 710 includes one or more TPMs 716. Alternatively, the TPM(s) may be implemented as discrete components. BMC 710 is coupled to CPU/SoC socket 701 via an SPI TPM link 721, an eSPI link 723, and an SMB 725. Flash storage device 712 is connected to CPU/SoC socket 701 via an SPI or eSPI link 727 and to BMC 710 via an SPI link 728. Flash storage device 712 stores firmware comprising IFWI 713. A power CPLD 706 provided various inputs 718 to CPU/SoC socket 701, such as wake signals, Sx signals, power button signals, etc. HW platform split logic 707 is implemented in CPLD 706, in the illustrated embodiment.

CPU/SoC socket 701 further includes a memory controller 735 coupled to a coherent interconnect 736 to which each of the cores in core tiles 702-0 and 702-1 are operatively coupled. Coherent interconnect 736 is an abstraction that represents a coherent memory domain comprising a cache hierarchy (e.g., Level 1 (L1 ), Level 2 (L2 ) and a Last Level Cache (LLC)) and associated cache agents and interconnect circuitry. Memory controller 735 is coupled to and provides Read and Write access to memory 738, which is used to store various firmware and software components, including an operating system and boot and runtime BIOS/Firmware. Coherent interconnect 736 is also connected to a UPI/UPX port 715 that operates as an interface to a socket-to-socket interconnect (not shown).

Platform architecture 700 further includes a storage device 744 and network interface 746 configured to be coupled to a network 748. Each of storage device 744 and network interface 746 is connected to a PCIe (Peripheral Component Interconnect Express) Root Port (RP) 750 on IO tile 702 via respective PCIe links 752 and 754. In one embodiment, all or a portion of platform software, such as an operating system, is stored in storage device 744 and loaded into memory 738.

Platform architecture 700 is further configured to implement the softstrap mode partition scheme discussed and illustrated above. As shown, a P-unit 732 is integrated onto core tile 702-0. As part of the platform partition mode configuration, P-unit 732 will access information in IFWI 713 during booting of CPU/SoC socket 701 to determine the partition mode configuration to be used.

FIG. 7a shows a platform architecture 700a that is configured to support the HW strap partition mode configuration scheme discussed and illustrated above. CPU/SoC socket 701a includes a strap pin 737, a HWRS block 734, and a P-unit 732. Otherwise, components with like reference numbers in FIGS. 7 and 7a are the same.

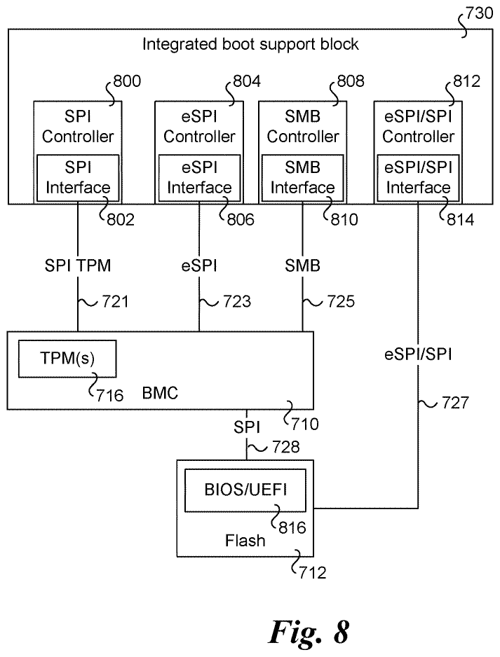

FIG. 8 shows further details of integrated boot support block 730, according to one embodiment. In this non-limiting example integrated boot support block 730 includes a plurality of IO controllers with integrated IO interfaces. These include an SPI controller 800 with SPI interface 802, an eSPI controller 804 with eSPI interface 806, an SMB controller 808 with SMB interface 810, and an eSPI or SPI controller 812 with an eSPI or SPI interface 814. Under an alternative configuration (not shown), the IO controllers and IO interfaces are separate. As further shown, BIOS/UEFI firmware 816 is stored in flash storage device 712.

While various embodiments described herein use the term System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

The following examples pertain to additional examples of the teachings and principles disclosed herein.
Example 1. A method performed on a multi-socket platform including first and second sockets interconnected by a socket-to-socket interconnect, the multi-socket platform being capable of being configured in a first partition mode with a single partition using both the first and second sockets and a second partition mode under which the first and second sockets are partitioned as respective first and second partitions, the method comprising: following the platform being operated in the single partition mode, rebooting the first socket to be operated as local socket in a separate partition under the second partition mode and under which communication over the socket-to-socket interconnect is disabled.
Example 2. The method of example 1, further comprising implementing a softstrap to effect configuration of the first socket in the first partition mode or the second partition mode.
Example 3. The method of example 2, wherein implementing the softstrap comprises: accessing information indicating the platform partition mode using a management controller operated by a user of the local socket to configure the local socket as a separate partition in local firmware for the local socket; accessing the local firmware for the local socket using a System on a Chip (SoC) or Central Processing Unit (CPU) for the local socket to determine a partition mode to be used for the first socket; and when the partition mode is a separate partition for the first socket, disabling a port on the SoC or CPU comprising an interface to the socket-to-socket interconnect.
Example 4. The method of example 3, further comprising utilizing platform split logic to enable the management control to be operated by the user to configure the local socket as a separate partition in the local firmware for the local socket.
Example 5. The method of any of the preceding claims, further comprising implementing a hardware strap to effect configuration of the local socket in the first partition mode or the second partition mode.
Example 6. The method of example 5, further comprising: using a local management controller communicatively coupled to the local socket to configure programmable logic coupled to the local socket to set a logic level on a hardware strap comprising a pin on a System on a Chip (SoC) or Central Processing Unit (CPU) installed in the local socket; and sensing the logic level of the pin to determine the local socket is to be operated in a separate partition.
Example 7. The method of example 6, wherein the logic level of the pin is sensed by a hardware reset sequencer (HWRS) block on the SoC or CPU.
Example 8. The method of example 6 or 7, further comprising: communicating a logic level or indicia indicating the partition mode for the local socket to a power unit on the SoC or CPU; and using the power unit to disable a port on the SoC or CPU comprising as an interface to the socket-to-socket interconnect.
Example 9. The method of any of the preceding claims, further comprising: after the platform has been operating in the second mode, initiating reboot of the first and second sockets; detecting the multi-socket platform is to be operated as in the first partition mode as a single partition; and establishing communication between the first and second sockets via the socket-to-socket interconnect.
Example 10. The method of example 9, further comprising implementing a respective softstrap or a hardware strap for each of the first and second sockets to effect configuration of the first and second sockets in the first partition mode.
Example 11. A multi-socket platform comprising: a board on which a plurality of components are mounted and including wiring interconnecting the plurality of components, the plurality of components including a first socketed connector associated with a first socket and a second socketed connector associated with a second socket; a socket-to-socket interconnect, electrically coupling the first socket to the second socket; wherein each of first and second sockets having associated components including, a System on a Chip (SoC) or CPU, installed in a respective socketed connector including a socket-to-socket interconnect port comprising an interface to the socket-to-socket interconnect; wherein the multi-socket platform is capable of being configured in a first partition mode with a single partition using both the first and second sockets and a second partition mode under which the first and second sockets are partitioned as respective first and second partitions; and following the platform being operated in the single partition mode, the platform is configurable to reboot the first socket to be operated as local socket in a separate partition under the second partition mode and under which communication over the socket-to-socket interconnect is disabled.
Example 12. The multi-socket platform of example 11, further configured to implement a softstrap to effect configuration of the first socket in the first partition mode or the second partition mode.
Example 13. The multi-socket platform of example 12, further comprising: a management controller, communicatively coupled directly or indirectly to the SoC or CPU for the socket; a programmable logic device, communicatively coupled directly or indirectly to the SoC or CPU for the socket; and at least one network interface, coupled directly or indirectly to the management controllers associated with the first and second sockets, wherein the management controller may be accessed via the network interface to enable a user to configure the multi-socket platform to be operated in the first partition mode or the second partition mode via the softstrap.
Example 14. The multi-socket platform of example 13, wherein the management controller is enabled to change a partition mode setting in a portion of local firmware for the first socket, and wherein during booting of the first socket the portion of local firmware is accessed by the SoC or CPU to determine the partition mode to be used for the first socket.
Example 15. The multi-socket platform of any of examples 11-14, further configured to implement a hardware strap to effect configuration of the first socket in the first partition mode or the second partition mode.
Example 16. The multi-socket platform of any of examples 11-15, wherein the SoC or CPU installed in the first socket is a local socket and further comprises: a mode strap pin implemented as a hardware mode strap; circuitry comprising logic for detecting a logic level of the mode strap pin, and circuitry to enable or disable the socket-to-socket internet port, wherein when the logic level indicates the first socket is to be operated in the first partition mode, enabling operation of the socket-to-socket internet port on the local SoC or CPU performing link training with a socket-to-socket interconnect port with a socket-to-socket interconnect port on an SoC or CPU installed in the second socket; otherwise, when the logic level indicates the first socket is to be operated in the second partition mode; disabling operation of the socket-to-socket interconnect port on the local SoC or CPU.
Example 17. A System on a Chip (SoC), configured to be installed in a first socket of a multi-socket platform including a second socket in which a second SoC is installed, the multi-socket platform including a socket-to-socket interconnect between the first socket and second socket, the SoC comprising: a plurality of processor cores, operatively coupled to an interconnect structure; a plurality of input-output (IO) interfaces, coupled to the interconnect structure, a socket-to-socket interconnect port coupled to the interconnect structure and comprising an interface to the socket-to-socket interconnect; a partition mode strap pin; circuitry comprising logic for detecting a logic level of the partition mode strap pin, and circuitry to enable or disable the socket-to-socket interconnect port, wherein when the logic level indicates the first socket is to be operated in the first partition mode, enabling operation of the socket-to-socket internet port on the SoC performing link training with a socket-to-socket interconnect port with a socket-to-socket interconnect port on an SoC installed in the second socket; otherwise, when the logic level indicates the first socket is to be operated in the second partition mode; disabling operation of the socket-to-socket internet port on the local SoC.
Example 18. The SoC of example 17, wherein the circuitry comprising logic for detecting a logic level of the partition mode strap pin comprises hardware reset sequencer (HWRS) block.
Example 19. The SoC of example 17 or 18, wherein the circuitry to circuitry to enable or disable the socket-to-socket internet port comprises a power unit.
Example 20. The SoC of example 19, wherein the SoC has a tile-based architecture comprising a plurality of tiles including: a first core tile having one or more processor cores including a bootstrap core and having the power unit; a second core tile having a plurality of processor cores interconnected with the first core tile; and an IO tile including at least a portion of the plurality of IO interfaces.
Example 21. The method of any of examples 1-10, wherein communication over the socket-to-socket interconnect is disabled without using any communication between the first and second sockets.
Example 22. The multi-socket platform of any of example 11-16, wherein communication over the socket-to-socket interconnect is disabled without using any communication between the first and second sockets

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by an embedded processor or the like. Thus, embodiments may be used as or to support a software program, software modules, firmware, and/or distributed software executed upon some form of processor, processing core, or embedded logic, or a virtual machine running on a processor or core or otherwise implemented or realized upon or within a non-transitory computer-readable or machine-readable storage medium. A non-transitory computer-readable or machine-readable storage medium includes any mechanism for storing or transmitting information in a form readable by a machine (e.g., a computer). For example, a non-transitory computer-readable or machine-readable storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A non-transitory computer-readable or machine-readable storage medium may also include a storage or database from which content can be downloaded. The non-transitory computer-readable or machine-readable storage medium may also include a device or product having content stored thereon at a time of sale or delivery. Thus, delivering a device with stored content, or offering content for download over a communication medium may be understood as providing an article of manufacture comprising a non-transitory computer-readable or machine-readable storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including non-transitory computer-readable or machine-readable storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments, including what is described in the Abstract, is not intended to be exhaustive or to limit the embodiments to the precise forms disclosed. While specific embodiments of, and examples for, the teachings and principles are described herein for illustrative purposes, various equivalent modifications are possible within the scope of the claims, as those skilled in the relevant art will recognize.

These modifications can be made to the embodiments in light of the above detailed description. The terms used in the following claims should not be construed to limit the claim scope to the specific embodiments disclosed in the specification and the drawings. Rather, the scope of the claims is to be determined entirely by the following claims, which are to be construed in accordance with established doctrines of claim interpretation.

What is claimed is:

1. A method performed on a multi-socket platform including first and second sockets interconnected by a socket-to-socket interconnect, the multi-socket platform being capable of being configured in a first partition mode with a single partition using both the first and second sockets and a second partition mode under which the first and second sockets are partitioned as respective first and second partitions, the method comprising:
following the platform being operated in the single partition mode,
rebooting the first socket to be operated as local socket in a separate partition under the second partition mode and under which communication over the socket-to-socket interconnect is disabled.

2. The method of claim 1, further comprising implementing a softstrap to effect configuration of the first socket in the first partition mode or the second partition mode.

3. The method of claim 2, wherein implementing the softstrap comprises:
accessing information indicating the platform partition mode using a management controller operated by a user of the local socket to configure the local socket as a separate partition in local firmware for the local socket;
accessing the local firmware for the local socket using a System on a Chip (SoC) or Central Processing Unit (CPU) for the local socket to determine a partition mode to be used for the first socket; and
when the partition mode is a separate partition for the first socket, disabling a port on the SoC or CPU comprising an interface to the socket-to-socket interconnect.

4. The method of claim 3, further comprising utilizing platform split logic to enable the management control to be operated by the user to configure the local socket as a separate partition in the local firmware for the local socket.

5. The method of claim 1, further comprising implementing a hardware strap to effect configuration of the local socket in the first partition mode or the second partition mode.

6. The method of claim 5, further comprising:
using a local management controller communicatively coupled to the local socket to configure programmable logic coupled to the local socket to set a logic level on a hardware strap comprising a pin on a System on a Chip (SoC) or Central Processing Unit (CPU) installed in the local socket; and
sensing the logic level of the pin to determine the local socket is to be operated in a separate partition.

7. The method of claim 6, wherein the logic level of the pin is sensed by a hardware reset sequencer (HWRS) block on the SoC or CPU.

8. The method of claim 6, further comprising:
communicating a logic level or indicia indicating the partition mode for the local socket to a power unit on the SoC or CPU; and
using the power unit to disable a port on the SoC or CPU comprising as an interface to the socket-to-socket interconnect.

9. The method of claim 1, further comprising:
after the platform has been operating in the second mode,
initiating reboot of the first and second sockets;
detecting the multi-socket platform is to be operated as in the first partition mode as a single partition; and
establishing communication between the first and second sockets via the socket-to-socket interconnect.

10. The method of claim 9, further comprising implementing a respective softstrap or a hardware strap for each of the first and second sockets to effect configuration of the first and second sockets in the first partition mode.

11. A multi-socket platform comprising:
a board on which a plurality of components are mounted and including wiring interconnecting the plurality of components, the plurality of components including a first socketed connector associated with a first socket and a second socketed connector associated with a second socket;
a socket-to-socket interconnect, electrically coupling the first socket to the second socket;
wherein each of first and second sockets having associated components including,
a System on a Chip (SoC) or CPU, installed in a respective socketed connector including a socket-to-socket interconnect port comprising an interface to the socket-to-socket interconnect;
wherein the multi-socket platform is capable of being configured in a first partition mode with a single partition using both the first and second sockets and a second partition mode under which the first and second sockets are partitioned as respective first and second partitions; and
following the platform being operated in the single partition mode, the platform is configurable to reboot the first socket to be operated as local socket in a separate partition under the second partition mode and under which communication over the socket-to-socket interconnect is disabled.

12. The multi-socket platform of claim 11, further configured to implement a softstrap to effect configuration of the first socket in the first partition mode or the second partition mode.

13. The multi-socket platform of claim 12, further comprising:
a management controller, communicatively coupled directly or indirectly to the SoC or CPU for the socket;
a programmable logic device, communicatively coupled directly or indirectly to the SoC or CPU for the socket; and
at least one network interface, coupled directly or indirectly to the management controllers associated with the first and second sockets,
wherein the management controller may be accessed via the network interface to enable a user to configure the multi-socket platform to be operated in the first partition mode or the second partition mode via the softstrap.

14. The multi-socket platform of claim 13, wherein the management controller is enabled to change a partition mode setting in a portion of local firmware for the first socket, and wherein during booting of the first socket the portion of local firmware is accessed by the SoC or CPU to determine the partition mode to be used for the first socket.

15. The multi-socket platform of claim 11, further configured to implement a hardware strap to effect configuration of the first socket in the first partition mode or the second partition mode.

16. The multi-socket platform of claim 11, wherein the SoC or CPU installed in the first socket is a local socket and further comprises:
a mode strap pin implemented as a hardware mode strap;
circuitry comprising logic for detecting a logic level of the mode strap pin, and
circuitry to enable or disable the socket-to-socket internet port,
wherein when the logic level indicates the first socket is to be operated in the first partition mode,
enabling operation of the socket-to-socket internet port on the local SoC or CPU performing link training with a socket-to-socket interconnect port with a socket-to-socket interconnect port on an SoC or CPU installed in the second socket; otherwise,
when the logic level indicates the first socket is to be operated in the second partition mode; disabling operation of the socket-to-socket interconnect port on the local SoC or CPU.

17. A System on a Chip (SoC), configured to be installed in a first socket of a multi-socket platform including a second socket in which a second SoC is installed, the multi-socket platform including a socket-to-socket interconnect between the first socket and second socket, the SoC comprising:
a plurality of processor cores, operatively coupled to an interconnect structure;
a plurality of input-output (IO) interfaces, coupled to the interconnect structure,
a socket-to-socket interconnect port coupled to the interconnect structure and comprising an interface to the socket-to-socket interconnect;
a partition mode strap pin;
circuitry comprising logic for detecting a logic level of the partition mode strap pin, and
circuitry to enable or disable the socket-to-socket interconnect port,
wherein when the logic level indicates the first socket is to be operated in the first partition mode,
enabling operation of the socket-to-socket internet port on the SoC performing link training with a socket-to-socket interconnect port with a socket-to-socket interconnect port on an SoC installed in the second socket; otherwise,
when the logic level indicates the first socket is to be operated in the second partition mode; disabling operation of the socket-to-socket internet port on the local SoC.

18. The SoC of claim 17, wherein the circuitry comprising logic for detecting a logic level of the partition mode strap pin comprises hardware reset sequencer (HWRS) block.

19. The SoC of claim 17, wherein the circuitry to circuitry to enable or disable the socket-to-socket internet port comprises a power unit.

20. The SoC of claim 19, wherein the SoC has a tile-based architecture comprising a plurality of tiles including:
a first core tile having one or more processor cores including a bootstrap core and having the power unit;
a second core tile having a plurality of processor cores interconnected with the first core tile; and
an IO tile including at least a portion of the plurality of IO interfaces.
